(19) United States
(12) Patent Application Publication
(10) Pub. No.: US 2011/0010222 A1
(43) Pub. Date: Jan. 13, 2011

(54) POINT-IN-TIME BASED ENERGY SAVING RECOMMENDATIONS

(75) Inventors: Samar Choudhary, Morrisville, NC (US); Gargi B. Dasgupta, Gurgaon (IN); Albee Jhoney, Bangalore (IN); Abdolreza Salahshour, Raleigh, NC (US); Balan Subramanian, Cary, NC (US); Akshat Verma, New Delhi (IN)

Correspondence Address: IBM RALEIGH IPLAW (DG);C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/499,179

(22) Filed: Jul. 8, 2009

(51) Int. Cl. G06Q 10/00

(52) U.S. Cl. 705/10

(57) ABSTRACT

Energy saving efforts should not compromise data center performance. An energy management application can determine usage patterns in historical energy usage data based on statistical analysis and energy models. Energy savings recommendations can be generated for future points-in-time based on the usage patterns. Business constraints can be applied to the energy savings recommendations to ensure that the energy savings recommendations meet performance requirements.

### BACKGROUND

Embodiments of the inventive subject matter generally relate to the field of energy management, and, more particularly, to point-in-time based energy saving recommendations.

Information technology (IT) equipment, and its supporting infrastructure, is a major consumer of power. Within five years, it is expected that IT data centers alone will consume 4.5% of the power produced in the United States. Data center power can be a major business expense. Reducing power consumption may qualify a data center for incentives offered by power companies allowing the data center to significantly reduce power expenses.

### SUMMARY

Embodiments include a method directed to retrieving historical usage data representing energy usage of a data center in response to a request to generate energy saving recommendations for the data center. In some embodiments, usage patterns in the historical usage data can be determined based on statistical analysis. Repetitions of the usage patterns can be determined. Energy saving recommendations that indicate energy saving actions to initiate at particular times can be generated based on the usage patterns and the repetitions. A business constraint of the data center can be determined. The energy saving recommendations can be refined based on the business constraint.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of generating energy savings recommendations based on historical usage data.

FIGS. 2-3 depict a flowchart of example operations for generating energy savings recommendations based on historical usage data.

FIG. 3 depicts a flowchart of example operations for generating energy savings recommendations based on historical usage data.

FIG. 4 depicts a flowchart of example operations for coalescing energy saving recommendations from multiple data centers.

FIG. 5 depicts a flowchart of example operations for reallocating workloads in a server cluster.

FIG. 6 depicts an example computer system.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to techniques for generating energy saving recommendations, embodiments may use the techniques for generating recommendations for workload reallocation, reduction of server pool size, etc. In other instances, well-known instruction instances, protocols, structures, and techniques have not been shown in detail in order not to obfuscate the description.

Reducing energy consumption in data centers is rapidly becoming a major business objective. However, data centers are subject to business constraints for performance (e.g., response times, availability, maximum central processing unit usage, etc.). Energy saving efforts should not compromise data center performance. An energy management application can determine usage patterns in historical energy usage data based on statistical analysis and energy models. Energy savings recommendations can be generated for future points-in-time based on the usage patterns. Business constraints can be applied to the energy savings recommendations to ensure that the energy savings recommendations meet performance requirements.

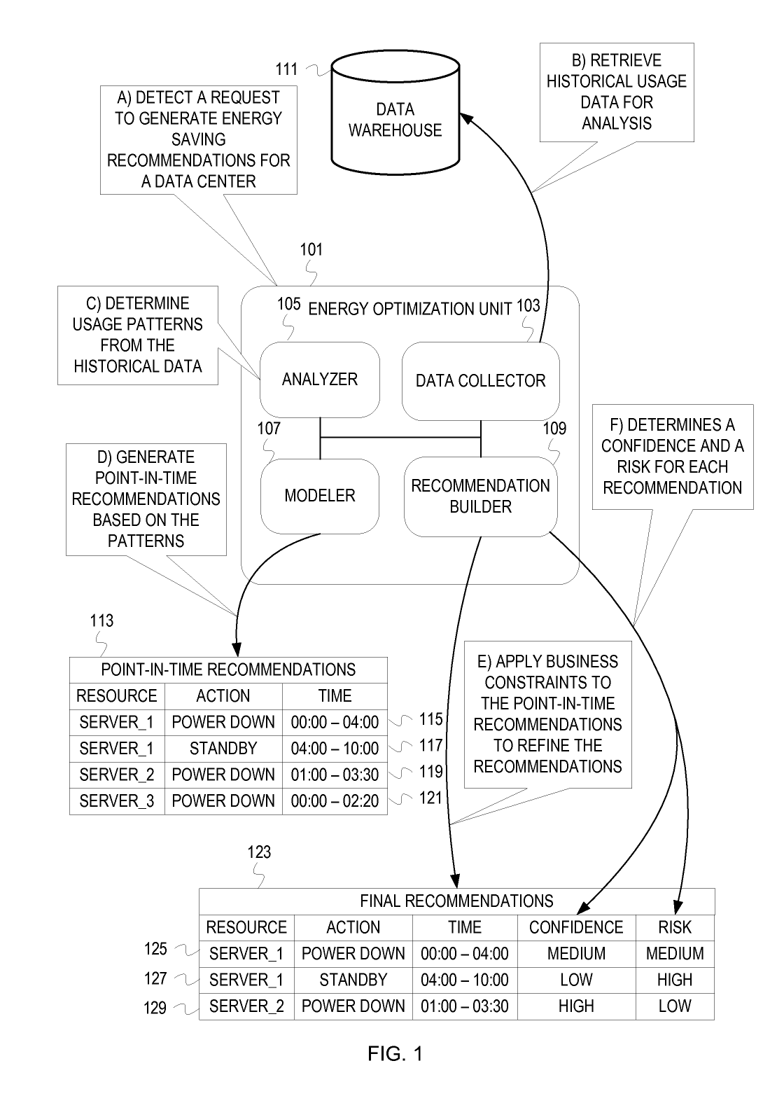

FIG. 1 is an example conceptual diagram of generating energy savings recommendations based on historical usage data. An energy optimization unit 101 comprises a data collector 103, an analyzer 105, a modeler 107, and a recommendation builder 109.

At stage A, the energy optimization unit 101 detects a request to generate energy savings recommendations for a data center. For example, the energy optimization unit 101 detects a Hypertext Transfer Protocol (HTTP) request.

At stage B, the data collector 103 retrieves historical usage data from a data warehouse 111 based on a specified data range. The date range indicates the historical usage data that should be retrieved from the data warehouse 111. For example, the date range indicates that historical data from the last month should be retrieved from the data warehouse 111. As another example, the date range indicates that historical data from the last quarter should be retrieved from the data warehouse 111. The data warehouse 111 stores central processing unit (CPU) usage, power consumption, temperature, performance data, utilization data, etc. for each resource in the data center. Examples of resources include servers, storage devices, routers, etc. The data is collected by agents, such as Eaton Power Xpert® agent, and IBM® Systems Director Active Energy Manager® (AEM).

At stage C, the analyzer 105 determines usage patterns from the historical data based on statistical analysis. The patterns can be determined over a specified date range and optimization interval. The analyzer 105 uses the optimization interval to divide the date range into smaller time intervals. For example, the optimization interval is 24 hours, so the analyzer 105 divides the date range into 24-hour time intervals. If the date range is a week, the analyzer divides the data range into seven time intervals. The analyzer 105 can determine one or more patterns within each of the time intervals. The analyzer 105 can then determine repetitions of the patterns over the entire date range. For example, the date range is a month and the optimization interval is a day. So, the analyzer 105 determines that a usage spike occurs every Monday from 09:00-10:00 during the month.

At stage D, the modeler 107 generates point-in-time recommendations based on the repetitions of the patterns. A point-in-time recommendation indicates one or more actions that can be taken to reduce energy usage/cost (“energy saving actions”). The point-in-time recommendation indicates when the one or more energy saving actions can be initiated, and when to terminate if necessary. Examples of energy saving actions include powering down a resource, putting a resource in standby mode, putting a resource in dynamic power savings mode, shifting workloads to more efficient servers, using Dynamic Voltage and Frequency Scaling (DVFS), deploying more efficient servers, etc. In this example, the modeler 107 generates four point-in-time recommendations 115, 117, 119, and 121. The point-in-time recommendation 115 indicates that server_1 should be powered down between 00:00 and 04:00 every day. The point-in-time recommendation 117 indicates that server_1 should be put in standby mode between 04:00 and 10:00 every day. The point-in-time recommendation 119 indicates that server_2 should be powered down between 01:00 and 03:30. The point-in-time recommendation 121 indicates that server_3 should be powered down between 00:00 and 02:20.

At stage E, the recommendation builder 109 applies business constraints to the point-in-time recommendations to refine the point-in-time recommendations into final recommendations. Business constraints indicate minimum performance criteria (e.g., response, availability, maximum CPU usage, etc.) that should be met by the data center and/or specific resources within the data center. In this example, a business constraint may indicate that at least one server should be available at all times. If all of the point-in-time recommendations are followed, the business constraint would be violated between 01:00 and 02:20 when all server_1, server_2, and server_3 are all powered down due to point-in-time recommendations 115, 119, and 121. So, the recommendation builder 109 adds point-in-time recommendations 115, 117, and 119 to the final recommendations. The recommendation builder 109 does not add point-in-time recommendation 121 because it violates the business constraint when compared in conjunction with the point-in-time recommendations 115 and 119.

At stage F, the recommendation builder 109 determines a confidence and a risk for each final recommendation. The confidence can represent quality of the historical data, quantity of the historical data (e.g., sample size), nature of recurrence of the patterns, etc. For example, a higher confidence would be determined for a final recommendation that is based on a month's worth of data, than for a final recommendation that is based on a week's worth of data. The risk can represent the likelihood of a particular final recommendation violating business constraints. For example, the risk is based on an average CPU utilization for a time period in which a server is recommended to be shutdown or placed in standby. Higher average CPU utilization for the time period leads to a higher risk because it is more likely that a server may be used. If the server is on standby or shutdown, business constraints for response time and/or availability may be violated.

In addition to the confidence and risk, the recommendation builder 109 may determine a cost savings for each final recommendation. The cost savings can be used along with the confidence and/or risk to analyze the effectiveness of a particular final recommendation. For example, a final recommendation indicates that a server should be shutdown between 20:00 and 05:00 every day. The risk is high while the cost savings is low. Because the final recommendation does not provide a significant cost savings and could lead to poor performance, the final recommendation should not be implemented.

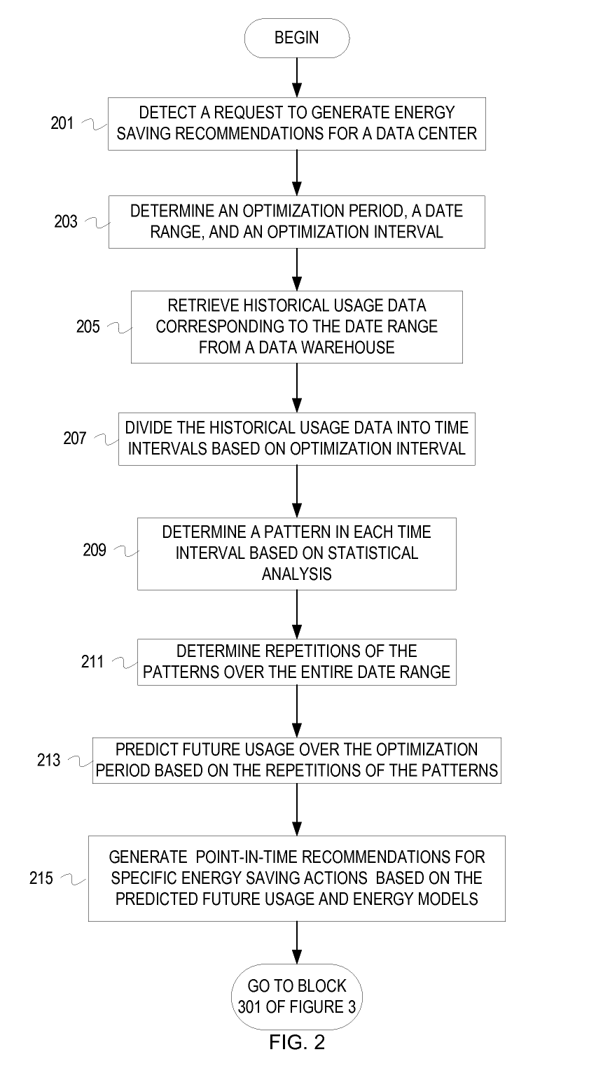

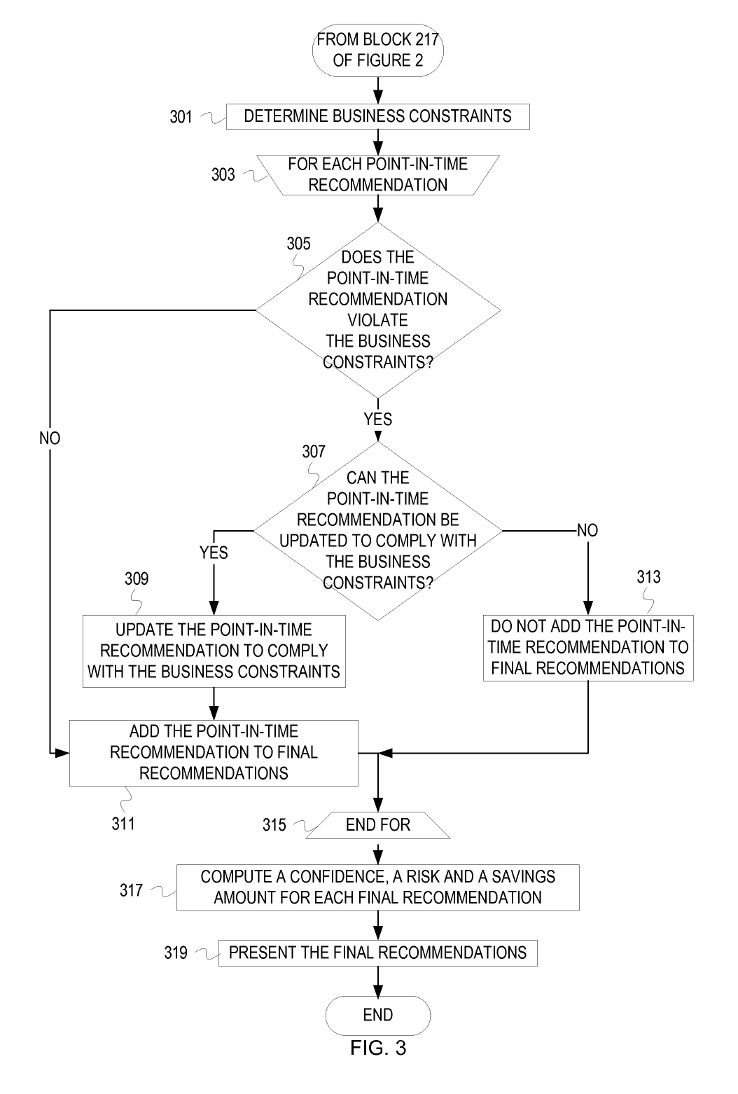

FIGS. 2-3 depict a flowchart of example operations for generating energy savings recommendations based on historical usage data. Flow begins at block 201, where a request to generate energy saving recommendation for a data center is detected. For example, completion of a wizard in an energy optimization application is detected.

At block 203, an optimization period, a date range, and an optimization interval determined from the request. The optimization period can represent the range of time over which energy savings recommendations should be made in the future. The date range indicates a time period for retrieving historical usage data. The optimization period and the date range may be expressed by a quantity (e.g., a month, a number of weeks, a year, etc.) or may be represented by start and end dates. The optimization interval can divide the date range into smaller time intervals for determining patterns in the date range based on statistical analysis. For example, a user may wish to generate energy saving recommendations for the next quarter based on the previous quarter's historical usage data. The optimization period is the next quarter. The date range is the previous quarter. The optimization interval may be any time interval that is smaller than the date range (e.g., a month, a day, a week, an hour, etc.).

At block 205, the historical usage data corresponding to the date range is retrieved from a data warehouse. For example, historical usage data from the past quarter is retrieved from the data warehouse.

At block 207, the historical usage data is divided into time intervals based on the optimization interval. For example, the optimization interval is a day (e.g., 24 hours) and historical usage data from the past quarter was retrieved from the data warehouse. The historical usage data is divided into 91 time intervals that represent usage for each day in the date range based on the optimization interval.

At block 209, patterns are determined in each time interval based on statistical analysis. Occurrence of peaks and troughs in the historical data can be determined for each time interval. Averages, standard deviations, variances for usage can be determined. Linear regression, polynomial approximation, etc. may be used for determining patterns in the historical data.

At block 211, repetitions of the patterns are determined over the entire date range. Patterns in each time interval can be compared to the other time intervals to determine which characteristics of the patterns repeat over the date range. For example, a date range of a month may be divided into 24-hour time intervals. Daily peaks and troughs may be compared to determine if the peaks and troughs occur within similar time thresholds each day. As another example, patterns may be compared for each weekday during the month to determine if a particular pattern repeats on Mondays for instance.

At block 213, future usage over the optimization period is predicted based on the repetitions of the patterns. For example, pattern repetitions in the date range indicate that past usage on Sundays is low, so usage on Sundays in the optimization period is predicted to be low as well. As another example, average usage is highest between 08:00 and 12:00 every day in the historical data, so average usage between 08:00 and 12:00 is predicted to be high in the optimization period.

At block 215, point-in-time recommendations for specific energy actions are generated based on the predicted future usage and energy models. The energy models can relate energy consumption of a resource to the resource's operations and are specific to each type of resource in the data center. For example, an energy model for a server relates energy usage to CPU utilization. The energy model can specify energy usage for idle, standby, and active CPU states. The energy model may also specify recovery times and energy usage for bringing a server up from shutdown, standby, dynamic power savings mode, etc. Point-in-time recommendations can be based on thresholds. For example, a point-in-time recommendation may be generated to shutdown a server if the predicted average CPU utilization falls below a threshold for a particular amount of time. The thresholds can be specified by a user or determined automatically. For example, the thresholds may be determined based on recovery information in the energy model. Flow continues at block 301 of FIG. 3.

FIG. 3 depicts a flowchart of example operations for generating energy savings recommendations based on historical usage data. Flow continues from block 215 of FIG. 2 at block 301, where business constraints are determined. For example, business constraints may be retrieved from the data warehouse. As another example, the business constraints may have been specified in the request.

At block 303, a loop begins for each point-in-time recommendation.

At block 305, it is determined if the point-in-time recommendation violates the business constraints. A point-in-time recommendation may not violate the business constraints alone, so violation of business constraints may be determined for the point-in-time recommendation alone or in conjunction with the other point-in-time recommendations. If the point-in-time recommendation violates the business constraints, flow continues at block 307. If the point-in-time recommendation does not violate the business constraints, flow continues at block 311.

At block 307, it is determined if the point-in-time recommendation can be updated to comply with the business constraints. For example, the point-in-time recommendation indicates that a server should be shutdown during a particular time period, but availability criteria in the business constraints are violated if the server is shutdown. The point-in-time recommendation may be modified to indicate that the server should be put in standby rather than shutdown if putting the server in standby does not violate the business constraints. If the point-in-time recommendation can be updated to comply with the business constraints, flow continues at block 309. If the point-in-time recommendation cannot be updated to comply with the business constraint, flow continues at block 313.

At block 309, the point-in-time recommendation is updated to comply with the business constraints. For example, the point-in-time recommendation indicates that a server should be on standby between 00:00 and 10:00. Business constraints specify a higher response time policy during business hours of 08:00 to 18:00 than during non business hours. The point-in-time recommendation may be updated to indicate that the server should be put on standby between 00:00 and 08:00.

At block 311, the point-in-time recommendation is added to final recommendations. For example, the point-in-time recommendation is written to an Extensible Markup Language (XML) file.

At block 313, the point-in-time recommendation violated business constraints and could not be updated, so the point-in-time recommendation is not added to the final recommendations. Although the point-in-time recommendation is not added to the final recommendations, the point-in-time recommendation may be stored so that it can be used in the future (i.e., if business constraints change). In addition, updated and original point-in-time recommendations may also be stored.

At block 315, the loop for each point-in-time recommendation ends.

At block 317, a confidence, a risk and a savings amount are computed for each final recommendation. The confidence can be based on the quality of the historical usage data. For example, a higher confidence would be computed for a final recommendation that is based on historical usage data that was sampled every minute, than a final recommendation that is based on historical usage data that was sample every hour. The risk can be based on the similarity between repetitions of the patterns over the date range. For example, a higher risk is computed for a final recommendation based on repetitions with a higher standard deviation (i.e., more jitter) than for a final recommendation based on repetitions with a lower standard deviation. The savings amount is computed based on the energy model and power rate information obtained from power companies. The optimization period can be used to select appropriate power rate information to compute the savings amount. The savings amount can be computed based on the difference between the predicted power usage and the power usage when following a final recommendation. For example, a point-in-time recommendation indicates that a server should be put on standby between 23:00 and 05:00 because the server is predicted to be idle. The savings amount would be computed based on the difference between the power usage if the server is idle and the power usage if the server is on standby between 23:00 and 05:00.

At block 319, the final recommendations are presented and flow ends. For example, the final recommendations may be presented in a graphical user interface (GUI). The GUI may utilize graphs and charts to display cost savings, comparisons between historical and predicted usage, comparisons between predicted usage with and without following the final recommendations, etc.

In addition, the final recommendations can be stored in a standardized format that will allow the final recommendations to be deployed in the data center. For example, the final recommendations are saved in an XML file. The final recommendations may be saved in the data warehouse so final recommendations can be accessed by a network management system that will deploy the final recommendations in the data center. The final recommendations may be deployed automatically based on thresholds. For example, final recommendations that have a confidence, a risk, and a savings amount above certain thresholds, are automatically deployed. The thresholds can be specified by a user or be default values. The final recommendations may also be deployed based on selection by a user.

Although examples refer to retrieving historical usage data and determining patterns in the historical usage data in response to a request to generate energy saving recommendations, embodiments are not so limited. Patterns may be periodically determined as new historical usage data is stored in a data warehouse. For example, patterns may be determined in the weekly historical data at the end of the week.

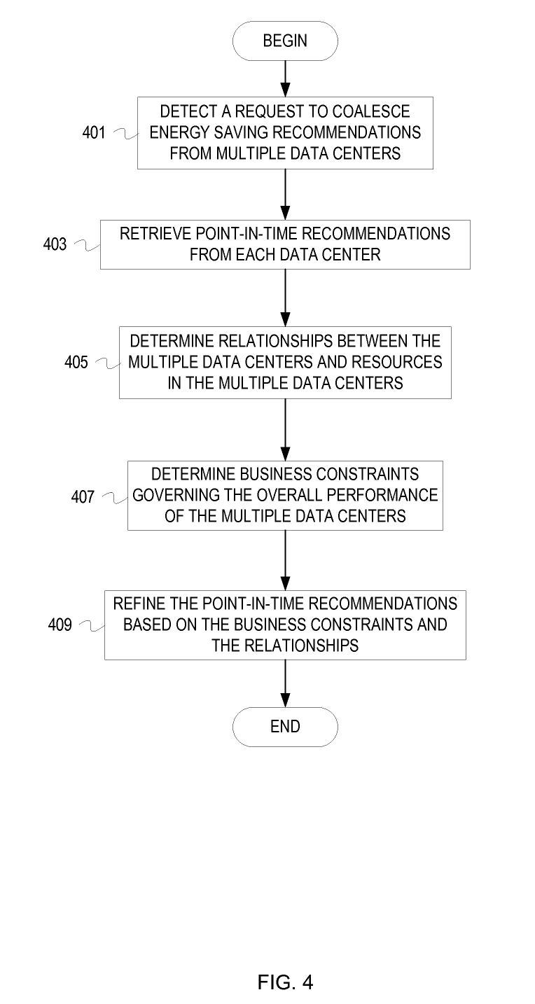

A company with multiple geographic locations may utilize multiple data centers. Energy saving recommendations can be generated for each data center, but the data centers may not operate entirely independently. The company may wish to implement energy saving recommendations that takes into account interdependencies between the multiple data centers. FIG. 4 depicts a flowchart of example operations for coalescing energy saving recommendations from multiple data centers. Flow begins at block 401, where a request to coalesce energy saving recommendations from multiple data centers is detected. For example, an option to coalesce energy saving recommendations is selected in an energy optimization application.

At block 403, point-in-time recommendations are retrieved from each data center. For example, the point-in-time recommendations are retrieved from local data warehouses in each data center.

At block 405, relationships between the multiple data centers and resources in the multiple data centers are determined. Relationships may comprise data dependencies, spatial relationships, compositional relationships, distribution of business services, etc. For example, servers that provide a company's intranet may be dispersed over different data centers, but the servers are related because they provide the same business service.

At block 407, business constraints governing the overall performance of the multiple data centers are determined. For example, business constraints are retrieved from data warehouse.

At block 409, the point-in-time recommendations are refined into final recommendations based on the business constraints and the relationships. For example, servers that provide a company's Voice over Internet Protocol are distributed among the company's multiple data centers. Point-in-time recommendations for each data center recommend putting each data center's VoIP server in standby outside of business hours. Business constraints indicate that at least one VoIP should be available at all times. Because VoIP calls can be routed from any company location to any VoIP server, one VoIP server is chosen to stay active and the point-in-time recommendation for that server is not included in the final recommendations. Confidences, risks, and savings amounts can be computed for each final recommendation.

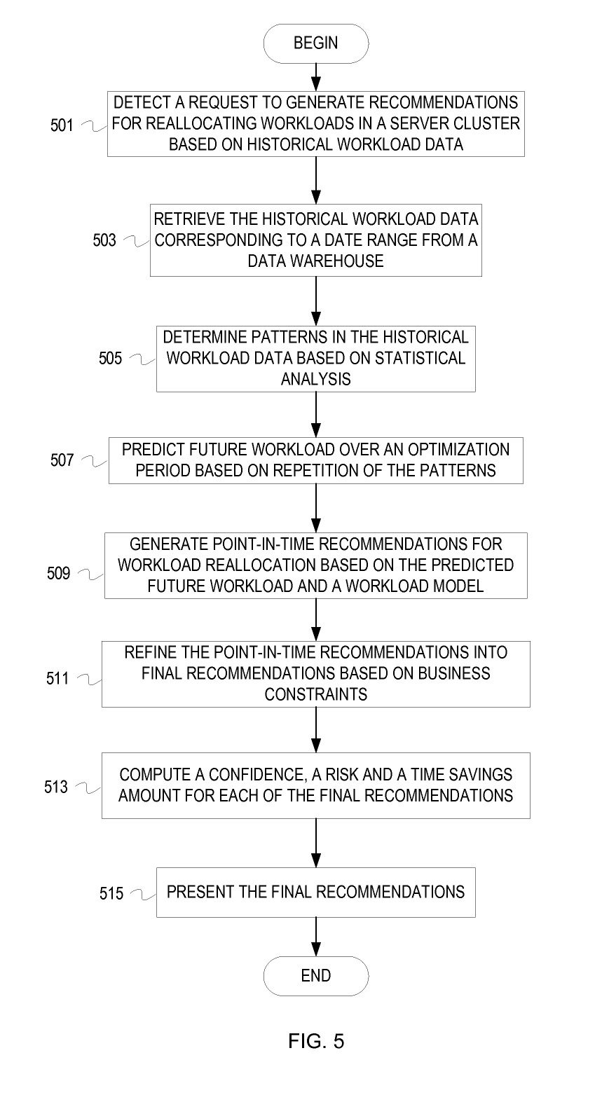

Techniques for generating energy saving recommendations can be extended for reallocating workloads, reducing server pool size, etc. FIG. 5 depicts a flowchart of example operations for reallocating workloads in a server cluster. Flow begins at block 501, where a request to generate recommendations for reallocation workloads in a server cluster based on historical workload data is detected.

At block 503, historical workload data corresponding to a date range is retrieved from a data warehouse. The date range is determined based on the request. Historical workload data can comprise CPU utilization, network utilization, disk utilization, task information (e.g., task type, urgency, etc), etc.

At block 505, patterns in the historical workload data are determined based on statistical analysis. The patterns can be determined based on optimization intervals within the date range. Statistical analysis can be performed on historical workload data from each optimization interval to determine occurrence of peaks and troughs, averages, standard deviations, variances and variances in the workload.

At block 507, future workload is predicted over an optimization period based on repetition of the patterns. For example, the future workload is predicted to peak at between 09:00 and 11:00 every day because patterns in the optimization intervals indicate a daily peak between 09:00 and 11:00 over the date range.

At block 509, point-in-time recommendations for workload reallocation are generated based on the predicted future workload and a workload model. The point-in-time recommendations indicate actions for reallocation workload at a particular time. Examples of actions for reallocation of workload include deploying servers with faster CPUs, assigning larger tasks to servers with more efficient processors, assigning smaller tasks to servers with less efficient processors, assigning particular types of task to particular servers, postponing non-critical tasks, reallocation a percentage of the workload from one server to another, etc. The workload model comprises performance information (CPU frequency, instructions per second, latency, etc) of each data center resource. The workload model is used to determine expected time to complete tasks so that appropriate actions for reallocation can be determined. For example, a server is predicted to have a CPU utilization at or above 90% between 02:00 and 04:00 every Friday. A point-in-time recommendation may be generated that indicates 20% of the server's workload should be reallocated to a second server between 02:00 and 04:00 on Fridays, because reallocating the workload will result in better efficiency for completing tasks that constitute the workload.

At block 511, the point-in-time recommendations are refined into final recommendations based on business constraints. For example, a point-in-time recommendation indicates 20% of a first server's workload should be reallocated to a second server between 02:00 and 04:00 on Fridays. The workload peak between 02:00 and 04:00 on Friday is due to payroll processing. A business constraint indicates that payroll processing should be handled by the first server for security reasons. So, the point-in-time recommendation may be refined to indicate that tasks other than payroll process should be reallocated to the second server between 02:00 and 04:00 on Fridays.

At block 513, a confidence, a risk, and a time savings amount is computed for each of the final recommendations. The confidence can be based on the quality of the historical usage data, quantity of the historical data, nature of recurrence of the patterns, etc. The risk represents the likelihood of each final recommendation violating business constrains and can be based on the similarity between repetitions of the patterns over the date range. The time savings amount is computed based on the workload model. The time savings amount can be computed based on the difference between a predicted task completion time and a completion time determined by following a final recommendation.

At block 515, the final recommendations are presented and flow ends. For example, the final recommendations may be presented in a GUI. The GUI may utilize graphs and charts to display time savings, comparisons between historical and predicted workload, comparisons between predicted workload with and without following the final recommendations, etc. As another example, the final recommendations may be saved, so that they can be reviewed at a later time.

It should be understood that the depicted flowcharts are examples meant to aid in understanding embodiments and should not be used to limit embodiments or limit scope of the claims. Embodiments may perform additional operations, fewer operations, operations in a different order, operations in parallel, and some operations differently. Referring to FIGS. 2 and 3, the operation for computing a confidence, a risk, and a savings amount may be performed before the operation for determining if the point-in-time recommendations violate business constraints. Referring to FIG. 4, the operation for retrieving the point-in-time recommendations and the operations for determining relationships may be interchanged.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

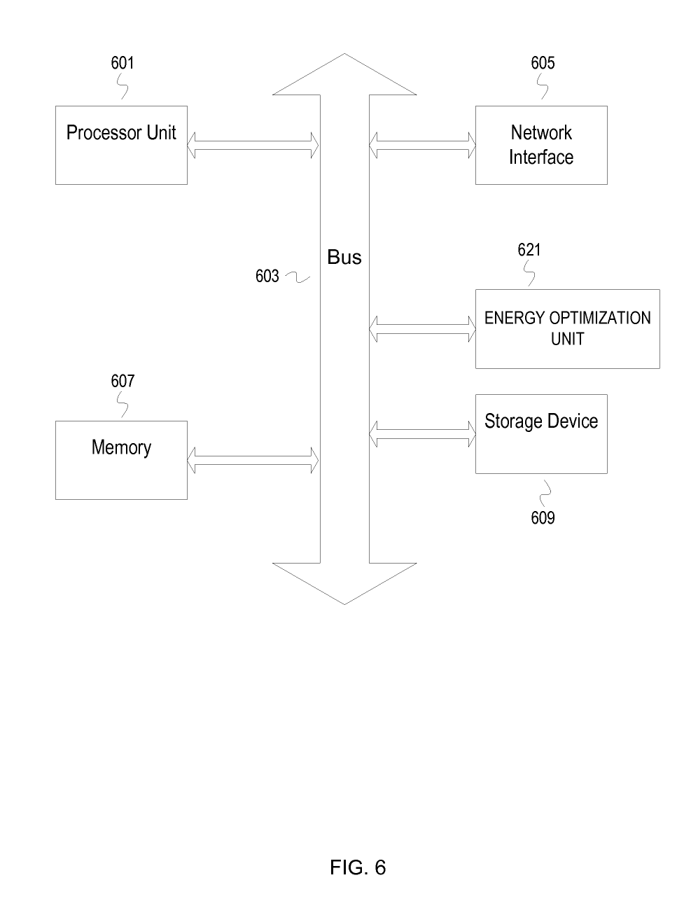

FIG. 6 depicts an example computer system. A computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport®, InfiniBand®, NuBus, etc.), a network interface 605 (e.g., an ATM interface, an Ethernet interface, a Frame Relay interface, SONET interface, wireless interface, etc.), and a storage device(s) 609 (e.g., optical storage, magnetic storage, etc.). The computer system also includes an energy optimization unit 621 that retrieves historical usage data from a data warehouse, determines patterns in the historical data, generates point-in-time recommendations based on the patterns, and refines the point-in-time recommendations based on business constraints. Any one of these functionalities may be partially (or entirely) implemented in hardware and/or on the processing unit 601. For example, the functionality may be implemented with an application specific integrated circuit, in logic implemented in the processing unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601, the storage device(s) 609, and the network interface 605 are coupled to the bus 603. Although illustrated as being coupled to the bus 603, the memory 607 may be coupled to the processor unit 601.

While the embodiments are described with reference to various implementations and exploitations, it will be understood that these embodiments are illustrative and that the scope of the inventive subject matter is not limited to them. In general, techniques for point-in-time based energy saving recommendations as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer implemented method comprising:
retrieving historical usage data in response to a request to generate energy saving recommendations for a data center, wherein the historical usage data represents energy usage of the data center;
determining usage patterns in the historical usage data based on statistical analysis;
determining repetitions of the usage patterns;
generating energy saving recommendations that indicate energy saving actions to initiate at particular times based on the usage patterns and the repetitions;
determining a business constraint of the data center; and
refining the energy saving recommendations based on the business constraint.

2. The computer implemented method of claim 1 further comprising storing the energy saving recommendations in a standardized format.

3. The computer implemented method of claim 1, wherein said determining the usage patterns in the historical usage data based on statistical analysis comprises:
determining an optimization interval, wherein the optimization interval represents a time period smaller than a past time period of the historical usage data;
dividing the historical usage data into time intervals based, at least in part, on the optimization interval; and
determining the usage patterns based on each of the time intervals.

4. The computer implemented method of claim 1, wherein the energy saving actions comprise one or more of powering down resources, putting resources in standby mode, putting resource in dynamic power savings mode, shifting workloads to more efficient resources, using Dynamic Voltage and Frequency Scaling, and deploying more efficient resources.

5. The computer implemented method of claim 1 further comprising computing a confidence, a risk, and a savings amount for each energy saving recommendation, wherein the confidence represents quality of the historical data, wherein the risk represents likelihood of the energy saving recommendation violating the business constraint.

6. The computer implemented method of claim 1, wherein said refining the energy saving recommendations based on the business constraint comprises:
determining that a first of the energy saving recommendations violates the business constraint;
determining that the first energy saving recommendation can be updated to comply with the business constraint; and
updating the first energy saving recommendation to comply with the business constraint.

7. A computer program product for generating energy saving recommendations, the computer program product comprising:
a computer usable medium having computer usable program code embodied therewith, the computer usable program code comprising:
computer usable program code configured to,
retrieve historical usage data in response to a request to generate energy saving recommendations for a data center, wherein the historical usage data represents energy usage of the data center;
determine usage patterns in the historical usage data based on statistical analysis;
determine repetitions of the usage patterns;
generate energy saving recommendations that indicate energy saving actions to initiate at particular times based on the usage patterns and the repetitions;
determine a business constraint of the data center; and
refine the energy saving recommendations based on the business constraint.

8. The computer program product of claim 7, wherein the computer usable program code being configured to retrieve historical usage data in response to a request to generate energy saving recommendations for a data center is based, at least in part, on a past time period.

9. The computer program product of claim 7, wherein the computer usable program code being configured to determine the usage patterns in the historical usage data based on statistical analysis comprises the computer usable program code being configured to:
determine an optimization interval, wherein the optimization interval represents a time period smaller than a past time period of the historical usage data;
divide the historical usage data into time intervals based, at least in part, on the optimization interval; and
determine the usage patterns based on each of the time intervals.

10. The computer program product of claim 7, wherein the computer usable program code is further configured to deploy the energy saving recommendations in the data center.

11. The computer program product of claim 7, wherein the computer usable program code is further configured to compute a confidence, a risk, and a savings amount for each energy saving recommendation, wherein the confidence represents quality of the historical data, wherein the risk represents likelihood of the energy saving recommendation violating the business constraint.

12. The computer program product of claim 7, wherein the computer usable program code being configured to refine the energy saving recommendations based on the business constraint comprises the computer usable program code being configured to:
determine that a first of the energy saving recommendations violates the business constraint;
determine that the first energy saving recommendation can be updated to comply with the business constraint; and
update the first energy saving recommendation to comply with the business constraint.

13. A computer program product for generating energy saving recommendations, the computer program product comprising:
a computer usable medium having computer usable program code embodied therewith, the computer usable program code comprising:
computer usable program code configured to,
detect a request to generate energy saving recommendations for a data center;
determine an optimization period, a date range, and an optimization interval based on the request;
retrieve historical usage data corresponding to the date range, wherein the historical usage data represents energy usage of a plurality of resources in a data center;
divide the historical usage data into time intervals based on the optimization interval;
determine a pattern in each time interval based on statistical analysis;
determine repetitions of the patterns within the date range;
predict future usage over the optimization period based on the repetitions;
generate energy saving recommendations that indicate specific energy saving actions at specific times based on the future usage;
determining a business constraint for the data center; and
refining the energy saving recommendations based on the business constraint; and
computing a confidence, a risk, and a savings amount for each energy saving recommendation.

14. The computer program product of claim 13 further comprises:
determine that the energy saving recommendations should be coalesced with second energy savings recommendations for a second data center;
retrieving the second energy saving recommendations from the second data center;
determining relationships between resources in the data center and the second data center;
determining second business constraint governing the overall performance of the data center and the second data center; and
refining the energy saving recommendations and the second energy saving recommendations based on the second business constraint and the relationships.

15. An apparatus comprising:
a processing unit;
a network interface; and
an energy optimization unit comprising:
a data collector operable to,
retrieve historical usage data in response to a request to generate energy saving recommendations for a data center, wherein the historical usage data represents energy usage of the data center;
an analyzer operable to,
determine usage patterns in the historical usage data based on statistical analysis;
determine repetitions of the usage patterns;
a modeler operable to,
generate energy saving recommendations that indicate energy saving actions to initiate at particular times based on the usage patterns and the repetitions; and
a recommendation builder operable to,
determine a business constraint of the data center; and
refine the energy saving recommendations based on the business constraint.

16. The apparatus of claim 15, wherein the data collector being operable to retrieve historical usage data in response to a request to generate energy saving recommendations for a data center is based, at least in part, on a past time period.

17. The apparatus of claim 15, wherein the analyzer being operable to determine the usage patterns in the historical usage data based on statistical analysis comprises the analyzer being operable to:
determine an optimization interval, wherein the optimization interval represents a time period smaller than a past time period of the historical usage data;
divide the historical usage data into time intervals based, at least in part, on the optimization interval; and
determine the usage patterns based on each of the time intervals.

18. The apparatus of claim 15, wherein the energy saving actions comprise one or more of powering down resources, putting resources in standby mode, putting resource in dynamic power savings mode, shifting workloads to more efficient resources, using Dynamic Voltage and Frequency Scaling, and deploying more efficient resources.

19. The apparatus of claim 15, wherein the recommendation builder is further operable to compute a confidence, a risk, and a savings amount for each energy saving recommendation, wherein the confidence represents quality of the historical data, wherein the risk represents likelihood of the energy saving recommendation violating the business constraint.

20. The apparatus of claim 15, wherein the recommendation builder being operable to refine the energy saving recommendations based on the business constraint comprises the recommendation builder being operable to:
determine that a first of the energy saving recommendations violates the business constraint;
determine that the first energy saving recommendation can be updated to comply with the business constraint; and
update the first energy saving recommendation to comply with the business constraint.
